(19) United States
(12) Patent Application Publication
(10) Pub. No.: US 2005/0116719 A1
(43) Pub. Date: Jun. 2, 2005

(54) Squid microscope for room temperature samples

(76) Inventors: Mehdi Fardmanesh, Ankara (TR); Jurgen Schubert, State College, PA (US); Marko Banzet, Geilenkirchen (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/496,777

(22) PCT Filed: Nov. 19, 2002
(86) PCT No.: PCT/DE02/04245

(30) Foreign Application Priority Data
Nov. 27, 2001 (DE) 101 58 096.7

(51) Int. Cl. G01V 3/00

(52) U.S. Cl. 324/345

(57) ABSTRACT

The invention relates to a component for a SQUID microscope and to a SQUID microscope. The aim of the invention is to provide a SQUID microscope which allows the adjustment of a very small distance between the sample and the microscope tip. The invention provides a substrate that has an edge. The closed-loop track that couples the sample to the SQUID and transmits the magnetic flux is led across said edge. The two faces of the substrate defining the edge form an angle that ranges between 90 and 180°. The provision of this angle makes it possible to bring the substrate together with the closed-loop track closer to the window of a vacuum chamber than previously. The sample to be tested is disposed behind said window.

The invention relates to a component for a SQUID-microscope as well as the SQUID-microscope itself.

The SQUID-microscope is commercially available. It encompasses a superconductive quantum interference detector [SQUID] with which magnetic fields can be detected with high sensitivity. The measurement signals of the SQUID represents the magnitude which is observed by means of the microscope and is evaluated. A SQUID must be operated at low temperatures which typically are about 77K.

The closed conductor path is comprised of superconductive material. Typically an yttrium barium copper oxide is used. The SQUID-element is comprised likewise of superconductive material.

The tip of a SQUID-microscope is formed by a closed superconductive conductor path. This is up to 150 μm thick at the end. The closed conductive path serves for the further conduction of the magnetic field of the SQUID. The diameter of a SQUID is typically 1.5 mm. A SQUID cannot therefore be used as a point or tip.

A SQUID comprises a closed conductive path with a Josephson contact [junction]. Preferred for a microscope is an rf-SQUID [radio frequency SQUID] and especially an rf-SQUID-gradiometer. An rf-SQUID-gradiometer is comprised of two closed conductive paths [tracks] with a Josephson contact. This is especially sensitive. Basically however any kind of SQUID can be used and thus also a DC-SQUID.

First, the closed conductive path used with a tip [point] serves for the further conduction of magnetic flux to the SQUID. In addition, in the case of an rf-SQUID, a tank circuit is provided so that variations in the closed conductive path of the SQUID can be measured. These variations produce variations of the voltage in the tank circuit. The mentioned voltage change is a measurement for the magnetic field to be measured.

In the case of a SQUID-microscope, the distance between the sample and the point of the microscope must be small in order to obtain good measurement results. It is however problemmatical that the tip of the microscope must have a temperature of 77° C. [should be 77K] or a lower temperature while the sample is at room temperature.

In order to realize this temperature difference, the tip of the microscope is provided in a vacuum chamber.

In order to keep the distance between the sample and the closed conductive path which serves for further conduction of the magnetic flux as low as possible, the window of the vacuum chamber has a groove, channel or cutout. The window is especially thin because of the groove, channel or cutout. Since the groove, channel or cutout is held to be very small, the thin location is not damaged by the vacuum in the interior of the chamber. Typically the window is 100 to 500 μm thick. At the bottom of the groove, channel or cutout, the thickness of the window sinks to typically 4.5 μm. The width of the groove, channel or cutout amounts in the state of the art typically to around 500 μm. With the invention, however, smaller widths can be realized.

In a highly efficient SQUID-microscope, the closed conductive track which serves for the further conduction of magnetic flow to the SQUID, is located as close as possible to the thin portion of the window, thus to keep the distance between the sample and the tip of the microscope as small as possible. According to the state of the art, this distance is less than 50 μm. A precondition for this is the use of a DC-SQUID since this can be relatively small.

The object of the invention is the preparation of a SQUID-microscope in which a very small spacing between the sample and the microscope tip is possible.

The object of the invention is achieved by a device with the features of the first claim. Advantageous refinements are given in the dependent claims.

By the “tip” of the microscope, one should understand the region of a closed superconductive conductor track which come the closest to the sample. This closed conductor track serves for the further conduction of the magnetic flux to the SQUID.

According to the invention the object is achieved in that a substrate is prepared which has an edge. The closed conductor track which couples the sample with the SQUID or serves for the further conduction of the magnetic flux is formed over the edge. The two sides bounding the edge of the substrate include an angle which lies between 90° and 180°. The provision of the angle enables the substrate together with the closed conductive track to be brought closer to the window than is possible by the state of the art. The Figures make the relationship clear.

Indeed within the closed conductor track there is a so-called “weak link” as soon as the conductor track passes the edge. This “weak link” is not desired. The disadvantageous effects of the “weak link” can however be avoided. For example, if the width of the closed conductor path is selected to be wide enough, no problems based upon a Josephson contact can arise. The critical current is then high enough so that at the working temperature the influence of the “weak link” can be negligible. The conductive track should be at least 5 μm wide.

In a further refinement of the invention, the edge is rounded so that the effect of a “weak link” can be reduced.

It has been found to be advantageous to reduce the spacing between a sample and the closed conductive track adjoining same to about 10 μm.

According to the invention enough space is provided so that the microscope, which encompasses an rf-SQUID-gradiometer, can have the aforementioned small spacing from the sample. An rf-SQUID-gradiometer is problematical since it requires a relatively large space. This encompasses namely other elements like for example a tank circuit. The invention also enables not only the spacing between the sample and microscope tip to be reduced by comparison with the state of the art, but at the same time enables sufficient space to be provided so that more sensitive SQUIDS can be used which however require more space.

In a further refinement, a plurality of SQUID-elements with a multiplicity of microscope tips which are formed by closed conductor tracks can be used so that gradiometric measurements can be carried out. A high resolution can then also be achieved.

Complicated constructions which encompass for example a labyrinth resonator for the further conduction of the magnetic flux to the SQUID-element may also be possible. This higher sensitivity by comparison to the state of the art can also be realized.

In a refinement of the invention, the closed conductive track at the end which serves to pick up the magnetic flux has additionally a tip of paramagnetic material. In this manner the local resolution can be further improved.

The part of the closed conductive track which is effective as the tip of the microscope can be only 5 μm in width. This enables an extremely high local resolution.

The closed conductor track is typically 5 μm in width. The width however is not critical. It is only to be noted that with increasing width of the conductor track or strip, the tip which serves to pick up the flux also becomes wider. As a result, there is a reduction in the local resolution.

The diameter at the location of the closed conductor strip at which the flux is picked up varies typically from 5 μm up to 150 μm. The diameter of the closed conductor track is suitably selected depending upon the particular use or purpose.

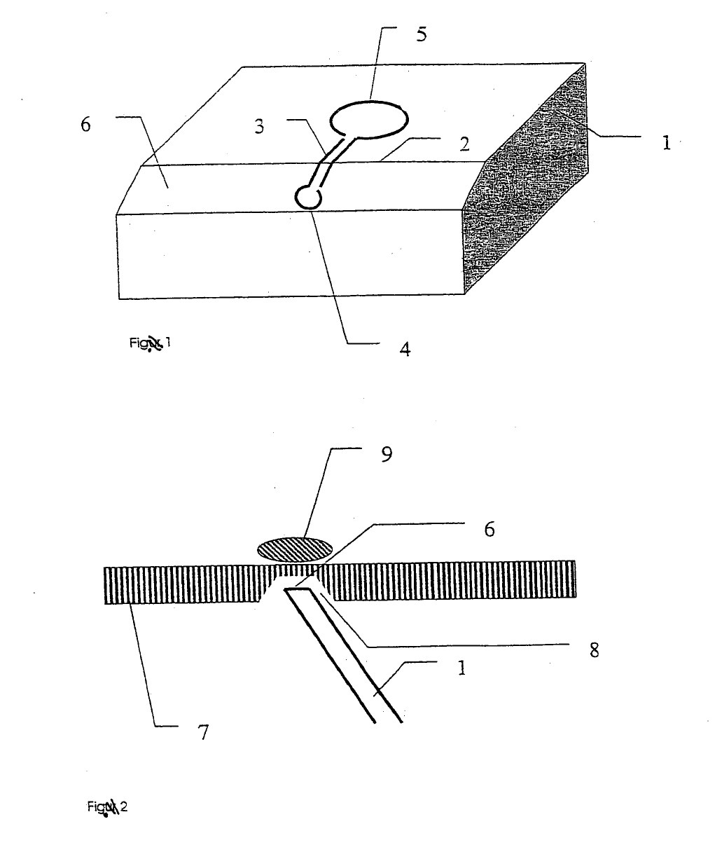

FIG. 1 shows a substrate 1 with an edge 2 and a closed conductive strip of superconductive material which extends over the edge 2. The partially circular region 4 of the closed conductive strip serves as a tip in a SQUID-microscope. The partially circular region 5 of the closed conductive strip bounds a SQUID which is here not illustrated.

FIG. 2 shows a window which is part of a vacuum chamber. The window 7 has a cutout 8 in which the substrate 1 extends. The surface 6 of the substrate, which carries the part 4 of the closed conductive loop serving as the microscope tip bounds the bottom of the cutout. During operation a sample 9 is provided on the other side of the window 7 adjoining the cutout 8. The spacing between the sample 9 and the microscope tip can thus be reduced to 10 μm.

To the extent that there has been no contrary description here, the microscope according to the invention can utilize the already known features of the state of the art.

1. A component for a SQUID-microscope with a substrate (1) that has an edge (2) and a closed conductive strip (3) which extends over the edge and is comprised of superconductive material.

2. The component according to claim 1 in which the edge (2) subdivides the corresponding surface of the substrate (1) into two regions, whereby one region (6) is small by comparison with the other region.

3. The component according to claim 2 in which the smaller region (6) is elongated and with one longitudinal side which adjoins the edge (2).

4. The component according to claim 1 in which the closed conductive strip encompasses a small partially circular segment (4) which has a diameter of 5 to 150 μm, preferably up to 20 μm.

5. The component according to claim 5 in which the closed conductive strip encompasses a further large partially circular segment (5) which is large by comparison with the small partially circular segment (4).

6. The component according to claim 1 in which a SQUID is applied to the substrate (1).

7. The component according to claim 1 in which a SQUID is applied to the substrate (1) and boarders on a large partially circular segment (5) of the closed conductive strip (3).

8. The component according to claim 1 with a window (7) and a groove, channel or cutout (8) in the window whereby the edge (2) of the substrate (1) is arranged within the groove, channel or cutout (8).

9. The component according to claim 1 in which the sides of the substrate (1) bounding the edge includes an angle which lies between 90° and 180°.

10. The component according to claim 1 in which the conductive strip (3) is at least 5 μm wide.

11. The component according to claim 1 in which the edge (2) is rounded.

12. The component according to claim 1 in which a sample is arranged at a distance from the substrate which lies between 10 and 30 μm.

13. The component according to claim 1 in which an rf-SQUID-gradiometer is applied to the substrate.

14. The component according to claim 1 in which a plurality of closed conductive strips (3) extend over the edge (2) and a SQUID borders on each closed conductive strip (3).

15. The component according to claim 1 in which the closed conductive strip encompasses a labyrinth resonator for the further conduction of the magnetic flux to a SQUID-element.

16. The component according to claim 1 in which the closed conductive strip (3) has a tip including a paramagnetic material which preferably is located within a small partially circular segment (4) of the conductive strip.

17. The component according to claim 1 in which the substrate (1) has a vacuum chamber.

18. The microscope having an opening with the features according to claim 1
